(19) United States
(12) Patent Application Publication
(10) Pub. No.: US 2025/0128746 A1
(43) Pub. Date: Apr. 24, 2025

(54) DUAL-PURPOSE HANDLING TRUCK

(71) Applicant: ZHEJIANG MICROLIFT INTELLIGENT EQUIPMENT CO., LTD., HANZHOU (CN)

(72) Inventors: DIGUO YUE, JIAXING (CN); WEN TANG, JIAXING (CN)

(21) Appl. No.: 19/001,504

(22) Filed: Dec. 25, 2024

Related U.S. Application Data
(63) Continuation of application No. PCT/CN2023/085900, filed on Apr. 3, 2023.

(30) Foreign Application Priority Data
Mar. 28, 2023 (CN) 202310335995.6

(51) Int. Cl. B62B 3/06; B62B 5/00; B66F 9/065; B66F 9/22

(52) U.S. Cl. CPC B62B 3/0612; B62B 5/0033; B62B 5/0066; B62B 5/0069; B66F 9/065; B66F 9/22; B62B 2203/10; B62B 2301/04

(57) ABSTRACT

Disclosed is a dual-purpose handling truck, which can be electrically controlled to walk or manually pushed and pulled to walk, and has two walking modes. A dual-purpose handling truck includes a front frame; a driving assembly and a lifting assembly are connected below and above the rear frame plate, respectively; the driving assembly includes a walking mechanism and a power mechanism for driving same; the walking mechanism includes a driving frame, on which a driving wheel is installed; the power mechanism controls a gear box to drive the driving wheel to rotate, so that the handling truck is electrically controlled to walk; the gear box is provided with a separation mechanism, which makes gears lose transfer torque and enables the driving wheel to rotate freely, so that the handling truck is manually pushed and pulled to walk; and the lifting assembly realizes the lifting of the handling truck.

### TECHNICAL FIELD

The present disclosure belongs to the technical field of handling trucks, and specifically relates to a dual-purpose handling truck.

### BACKGROUND

Handling trucks are logistics handling equipment for handling goods. The handling trucks are divided into two series, i.e., a manual series and an electric series. The handling trucks have two main functions: walking and lifting. Walking is realized by rolling of wheels, which can be pushed and pulled by an operator or driven by a motor. Lifting is achieved through a hydraulic system, which may be manual lifting or electric lifting.

The electric-driven walking of an existing handling truck is implemented by using a motor to electrically control the rotation of wheels through a gear box. When an output shaft of the motor rotates, gears engaged in the gear box rotate, so as to drive the wheels to rotate. Once the motor cannot be used normally, the gear box cannot operate normally, and the handling truck will stop moving; and it is difficult to manually push the handling truck to move, because the gears in the gearbox are engaged, it is hard for the rotational force of tires to drive the gears to rotate in reverse. As a result, the output shaft of the motor will not rotate. Therefore, the handling truck will stop in the middle of a road and thus poses a safety hazard.

### SUMMARY

In view of the above disadvantages in the Background, the purpose of the present disclosure is to provide a dual-purpose handling truck, which can be electrically controlled to walk or manually pushed and pulled to walk, and has two walking modes.

In order to solve the above technical problems, the purpose of the present disclosure is achieved in such a way that:

A dual-purpose handling truck includes a front frame, and a rear end of the front frame is connected to a rear frame plate; a driving assembly is connected below the rear frame plate, and a lifting assembly is connected above the rear frame plate;
the driving assembly includes a walking mechanism and a power mechanism for driving; the walking mechanism includes a driving frame, and a driving wheel is installed on the driving frame;
the power mechanism controls a gear box to drive the driving wheel to rotate, so that the handling truck is electrically controlled to walk; the gear box is provided with a separation mechanism, making the gear box lose transfer torque and enabling the driving wheel to rotate freely, so that the handling truck is manually pushed and pulled to walk;
the lifting assembly realizes the lifting of the handling truck.

On the basis of the above solution and as an exemplary solution of the above solution: the gear box is installed on the driving frame, and an output end of the gear box is connected to the driving wheel; a drive motor drives the driving wheel to rotate through the gear box; the lifting assembly includes a pump housing, an oil tank is provided at one end of the pump housing, the oil tank is internally provided with a high-pressure chamber, the high-pressure chamber is filled with high-pressure oil, and a piston rod is arranged inside the high-pressure chamber; a hand pump housing is provided at the other end of the pump housing, and a hand pump core is arranged inside the hand pump housing; the hand pump housing is in communication with the oil tank through an oil circuit A, a first one-way valve is arranged on the oil circuit A, and the hand pump housing is in communication with the high-pressure oil through an oil circuit B; and a return valve is provided on the oil circuit A for opening the first one-way valve to control the high-pressure oil to flow back to the oil tank.

On the basis of the above solution and as an exemplary solution of the above solution: the driving frame includes a first connecting plate, and two first support plates that are opposite to each other are provided on a lower surface of the first connecting plate; a rotatable axle is arranged between bottoms of the two first support plates, and the driving wheel sleeves the axle; a steering pin shaft is inserted between tops of the two first support plates; the steering pin shaft passes through a bottom of the pump housing and supports the entire lifting assembly to bear force; the first connecting plate is provided with a first mounting hole penetrating through upper and lower surfaces thereof; a first fixing block fixed by being embedding into the first mounting hole protrudes from a top surface of the first support plate; the axle is hollow inside, and a first flange protrudes from a surface of the axle; a second flange is arranged in the middle of the driving wheel, the driving wheel is fitted into the axle, and the first flange is bolted to the second flange for fixation; and both ends of the steering pin shaft are clamped into retaining rings for fixation.

On the basis of the above solution and as an exemplary solution of the above solution: the gear box includes a box body, and a box cover fitted with the box body, and the box body and the box cover are assembled to form an installation chamber; a gear set is installed inside the box body, and the separation mechanism is arranged inside the gear set; and the separation mechanism enables the engagement or separation of the gear set, so that the gear set has the function of transmitting torque output or terminating torque output.

On the basis of the above solution and as an exemplary solution of the above solution: the gear set includes an input gear and an outgoing shaft; a housing of the drive motor is bolted to the box body for fixation; an output shaft of the drive motor is inserted into the box body, and the output shaft of the drive motor is engaged with the input gear; the outgoing shaft penetrates out of the box body and is inserted into the driving wheel to drive rotation; the separation mechanism includes a key sleeve, an inner key of the key sleeve is engaged with a key shaft, and an outer key of the key sleeve is engaged with a keyway of a transmitting gear; the key sleeve is movable axially on the key shaft; when the outer key of the key sleeve is separated from the keyway on the transmitting gear, torque transmission between the transmitting gear and the key sleeve is lost; the key sleeve is located at one end of the key shaft; the transmitting gear sleeves the middle of the key shaft; the transmitting gear is engaged with the input gear and the transmitting gear is rotatable around the key shaft; a tooth groove that meshes with the outer key of the key sleeve is formed in a side face of the transmitting gear; the outer key is embedded into the tooth groove, and the key sleeve rotates synchronously with the transmitting gear, while the key sleeve drives the key shaft to rotate; a drive gear is arranged at the other end of the key shaft; the key shaft drives the drive gear to rotate, and the drive gear is engaged with the outgoing shaft for synchronous rotation; and the input gear, the outgoing shaft, the transmitting gear, the drive gear, and the key shaft are clamped between the box body and the box cover for fixation.

On the basis of the above solution and as an exemplary solution of the above solution: the handling truck further includes a secondary shaft, where a secondary pin pit is provided at one end of the secondary shaft, the input gear is fitted into the secondary shaft and embedded into a secondary pin column for clamping and fixing, a secondary gear protrudes from a surface of the other end of the secondary shaft, and the secondary gear is engaged with the transmitting gear.

On the basis of the above solution and as an exemplary solution of the above solution: an outer surface of the key sleeve is recessed in the middle to form an annular first clamping slot; the handling truck also includes a shifting column; the shifting column is rod-shaped, and a tail end of the shifting column passes through the box cover and is then inserted into the box body; a shifting fork is fixed on the shifting column, the shifting fork includes two legs, and an arc-shaped first notch is reserved between the two legs; a top of the shifting fork is provided with a shaft hole for the insertion and fixation of the shifting column; the first clamping slot of the key sleeve is clamped by the two legs of the shifting fork; the shifting column drives the shifting fork to move, and the shifting fork synchronously drives the key sleeve to move on the key shaft so as to realize the separation or assembly of the key sleeve and the transmitting gear; a middle end surface of the shifting column is recessed to form a first concave pit; a through first threaded hole is provided in the shaft hole, and a hexagon socket head cap screw is screwed into the first threaded hole and inserted into the first concave pit for fixation; a tail end surface of the shifting column is provided with two circles of side-by-side annular second clamping slots; the box body is provided with a second threaded hole, and a steel ball jack screw is screwed into the second threaded hole and jacked against the second clamping slots to play a limiting role; and a through first hanging hole is provided in a head end surface of the shifting column, and a pull ring is arranged in the first hanging hole in a penetrating manner.

On the basis of the above solution and as an exemplary solution of the above solution: a gear pump is arranged at one side of the pump housing, and an oil inlet and an oil outlet are provided on the gear pump; the gear pump is connected to a lifting motor, and the lifting motor is configured to control the gear pump to suck oil or inject oil; an oil inlet pipe is in communication between the oil inlet and the oil tank; and an oil outlet pipe is connected to the oil outlet, the oil outlet pipe is in communication with the high-pressure oil through an oil circuit C, and a second one-way valve is provided on the oil circuit C.

On the basis of the above solution and as an exemplary solution of the above solution: the first one-way valve includes a steel ball, a one-way valve body, a valve core and a volute spring; the valve core is inserted into the one-way valve body, the volute spring is jacked against the one-way valve body, the steel ball is jacked against the valve core, and the steel ball is located at an oil outlet part of the oil circuit A; an oil return valve is located directly opposite the first one-way valve, and the steel ball is located on one side of the oil return valve; the oil return valve includes a needle seat, a striker and a limit spring; a tail of the striker is inserted into the needle seat to play a limiting role, and a head of the striker is slender and inserted into the limit spring; the limit spring is jacked against the striker for fixation; the striker is configured to push away the steel ball to achieve oil return; and the second one-way valve includes an oil passage bolt, a built-in one-way valve and an oil seal gasket, where the built-in one-way valve is arranged inside the oil passage bolt, the oil passage bolt is in communication between the oil outlet pipe and the oil tank, and the oil seal gasket is clamped between the oil passage bolt and the pump housing for fixation.

On the basis of the above solution and as an exemplary solution of the above solution: the handling truck also includes a protective cover, where the protective cover is bent into a cover shape, a top of the protective cover fits the first connecting plate and is fixedly connected through bolts, and a surface body of the protective cover covers the entire driving assembly; the handling truck also includes a wire harness board, where the wire harness board is bent into an L shape, a bottom of the wire harness board is connected and fixed to the first connecting plate through bolts, and a top of the wire harness board is recessed from two side faces to form a rectangular bayonet; and the handling truck also includes a left outer cover and a right outer cover, where the left outer cover and the right outer cover respectively cover a left side face and a right side face of the pump housing, and a double-ended screw passes through the left outer cover and the right outer cover for realizing fixed connection therebetween.

Compared with the prior art, the present disclosure has the following outstanding and beneficial technical effects.

According to the dual-purpose handling truck provided by the present disclosure, compared with the prior art, the beneficial effects are as follows.
1. The handling truck is provided with the drive motor and the gear box, thus being capable of realizing electric-driven walking; the gear box is provided with the separation mechanism, which enables the driving wheel to rotate freely, so that the handling truck is manually pushed and pulled to walk; and therefore, the handling truck achieves the effect of being dual-purpose driven.
2. The handling truck is provided with the hand pump housing, the hand pump core is arranged inside the hand pump housing, and the hand pump housing is in communication with the high-pressure oil through the oil circuit B, achieving the effect of manually lifting a piston rod; the pump housing is provided with the gear pump and the lifting motor to achieve the effect of electrically lifting the piston rod; and the one-way valve is available on the oil circuit C, and the oil flow direction is single. It can achieve electric lifting and manual lifting at the same time, and thus has a dual-purpose lifting effect. When the two methods are superimposed for lifting, the piston rod lifting speed is faster. The return oil goes through the oil circuits B and A, resulting in a simpler internal structure.
3. The gear box is internally provided with the input gear and an output gear, the input gear is engaged with the input shaft of the drive motor to provide a power source, while the output gear drives the driving wheel to rotate through the outgoing shaft, achieving walking;
the separation mechanism is additionally arranged between the input gear and the output gear; the separation mechanism includes a key shaft, a key sleeve sleeved outside the key shaft, and the transmitting gear, where the drive gear is fixed on the key shaft; and the outer key is arranged on a surface of the key sleeve, and the transmitting gear is provided with a tooth groove matched with the outer key.

Through the assembly of the transmitting gear and the key sleeve, the key sleeve rotates, driving the key shaft to rotate, the drive gear to rotate, and the output gear to rotate. On the contrary, the key sleeve is separated from the transmitting gear and cannot be driven by electricity, but the driving wheel is not restricted by the transmitting gear, and there is no situation where all the gears are engaged; and therefore, the driving wheel can rotate freely, which achieves the driving effect by manually pulling and pushing, and implements two driving modes in one gear box, thus killing two birds with one stone.
4. The separation mechanism may be provided with the secondary gear or a multistage gear to achieve different reduction ratios, which is more practical.
5. The handling truck also includes the shifting column, the shifting column is connected to the shifting fork, and the shifting fork sleeves the key sleeve. By inserting and removing the shifting column, the shifting fork is moved, achieving the effect of the key sleeve moving on the key shaft.
6. The hexagon socket head cap screw passes through the shifting fork and is fixed with the shifting column, so as to prevent the shifting column from being pulled out of the shifting fork, and allow the shifting fork to be blocked by the box cover, thus killing two birds with one stone. The two second clamping slots are provided at the tail of the shifting column, corresponding to the assembled and separated states respectively. The steel ball jack screw is jacked against the second clamping slots, which is convenient for an operator to perceive, thus being more user-friendly.
7. The protective cover covers the driving assembly to protect the handling truck and the operator.
8. The rectangular bayonet of the wire harness board can restrain and fix wires, making them tidier and safer.
9. The left and right outer covers wrap the pump housing to play a protective role; and the double-ended screw passes through the left outer cover and the right outer cover, making it possible to disassemble and replace same.

### BRIEF DESCRIPTION OF FIGURES

FIG. 1 is a schematic diagram of the overall structure of the present disclosure.

FIG. 2 is a schematic diagram of the overall structure of the present disclosure.

FIG. 3 is a schematic diagram of the overall explosive structure of the present disclosure.

FIG. 4 is a schematic diagram of the explosive structure of a lifting assembly according to the present disclosure.

FIG. 5 is a schematic diagram of the partial installation structure of the lifting assembly according to the present disclosure.

FIG. 6 is a schematic diagram of the oil circuit structure of the present disclosure.

FIG. 7 is a schematic diagram of the explosive structure of a driving assembly according to the present disclosure.

FIG. 8 is a schematic diagram of the partial explosive structure of a power mechanism according to the present disclosure.

FIG. 9 is a schematic diagram of the cross-sectional structure of FIG. 8.

FIG. 10 is a schematic diagram of the partial cross-sectional structure of FIG. 8.

FIG. 11 is a schematic diagram of the partial cross-sectional structure of FIG. 8.

FIG. 12 is a schematic diagram of the partial explosive structure of the driving assembly according to the present disclosure.

FIG. 13 is a schematic diagram of the structure of a wire harness board according to the present disclosure.

FIG. 14 is a schematic diagram of the explosive structure of the lifting assembly according to the present disclosure.

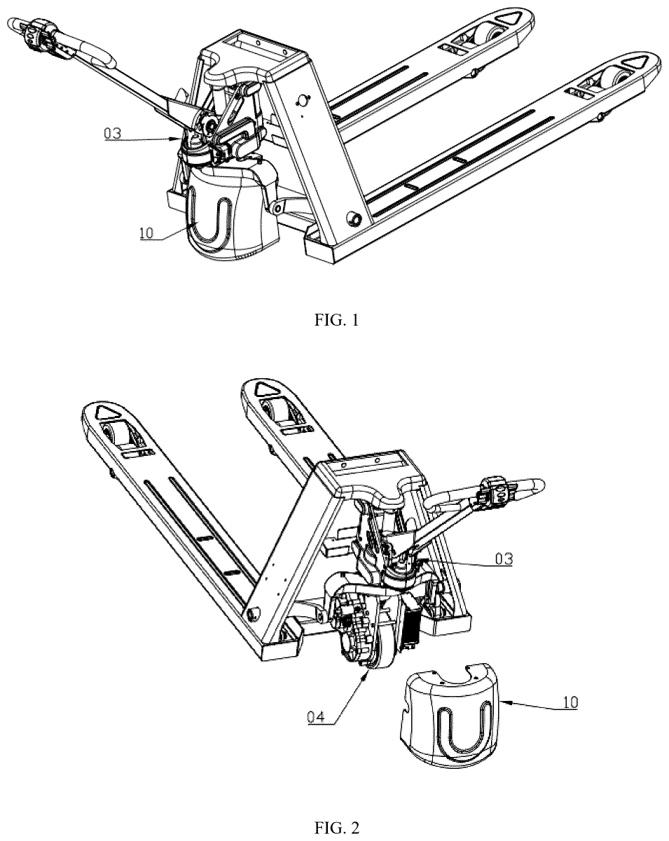

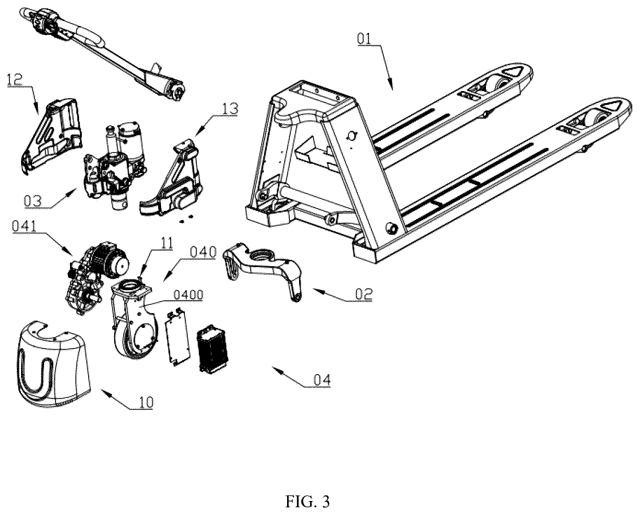

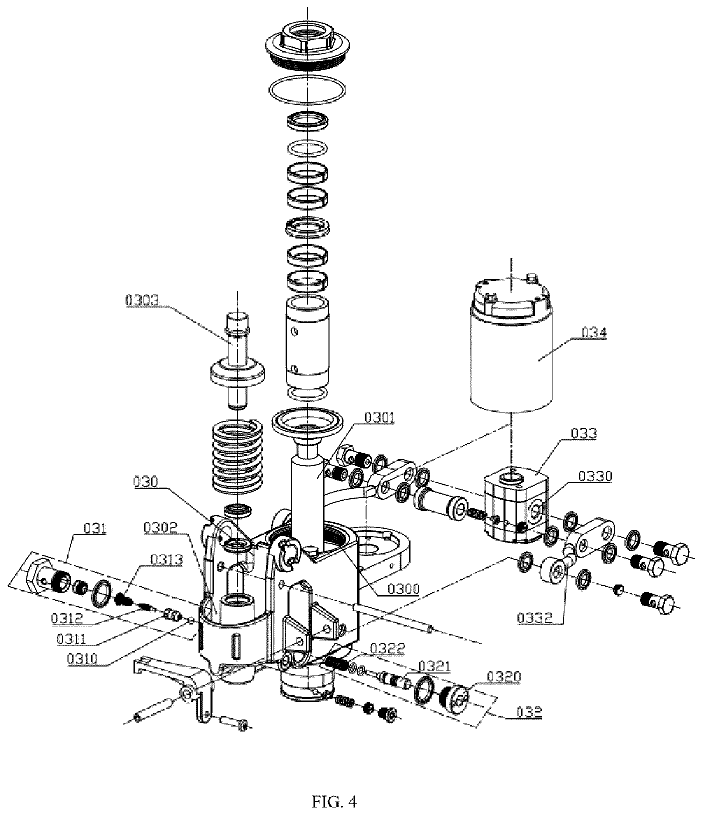

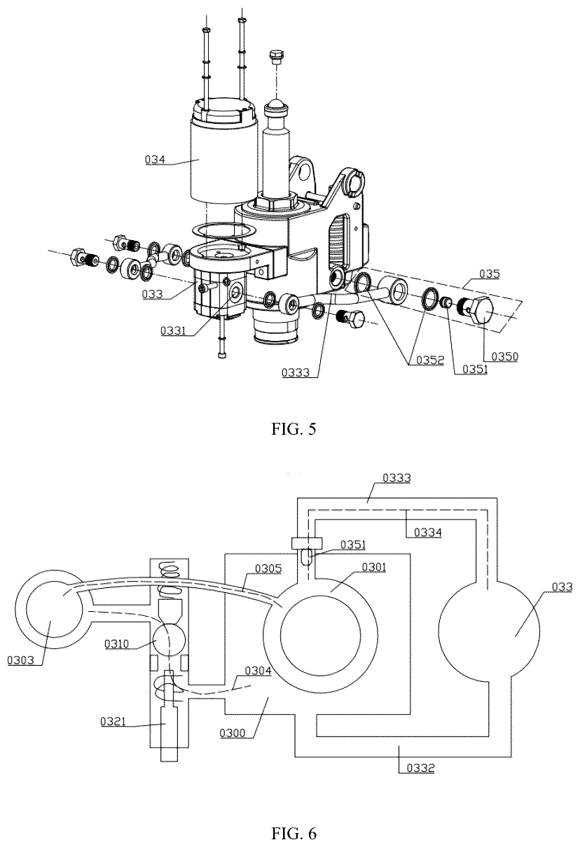

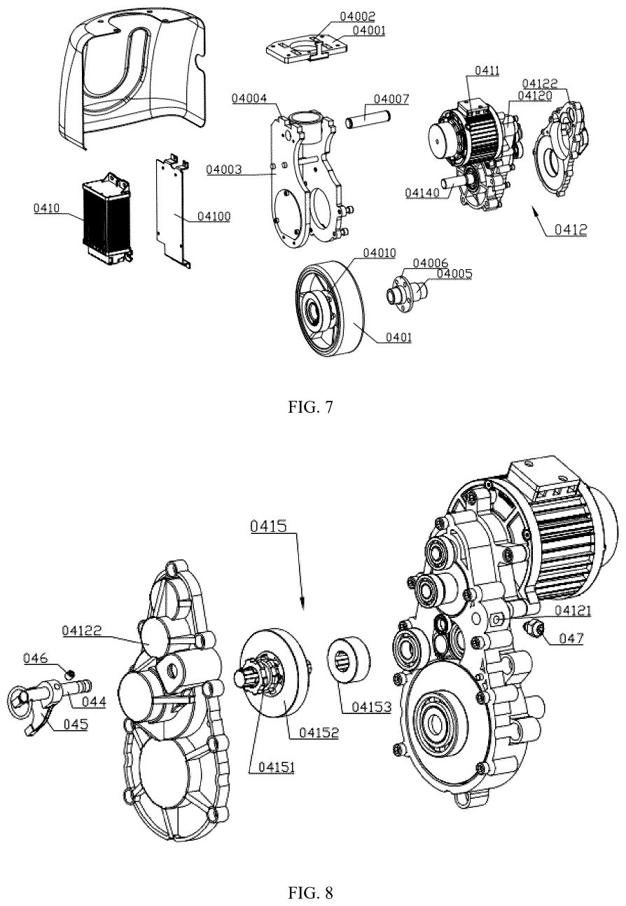

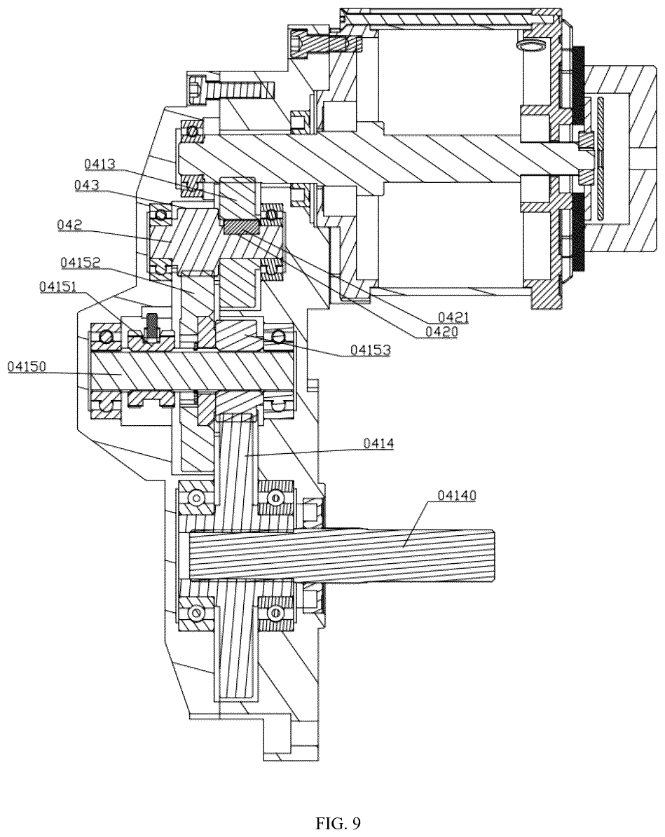

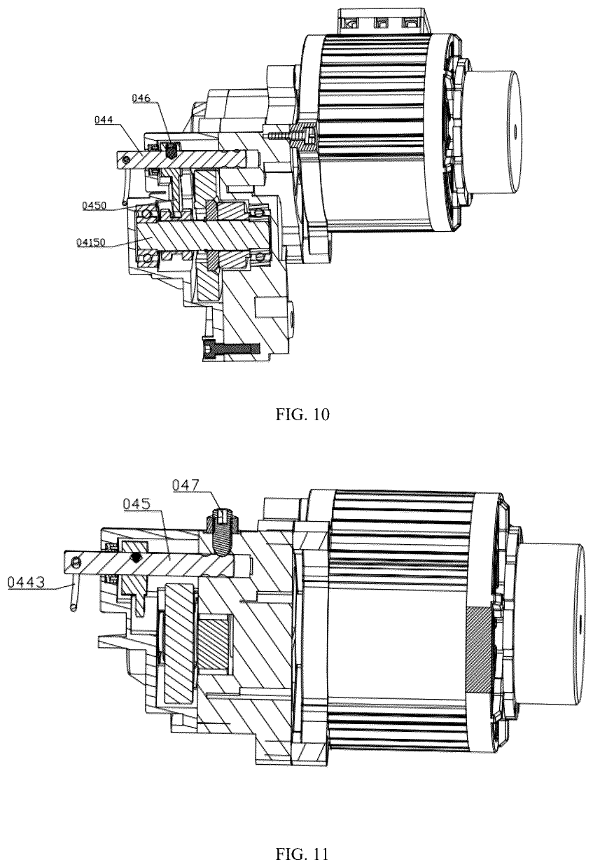

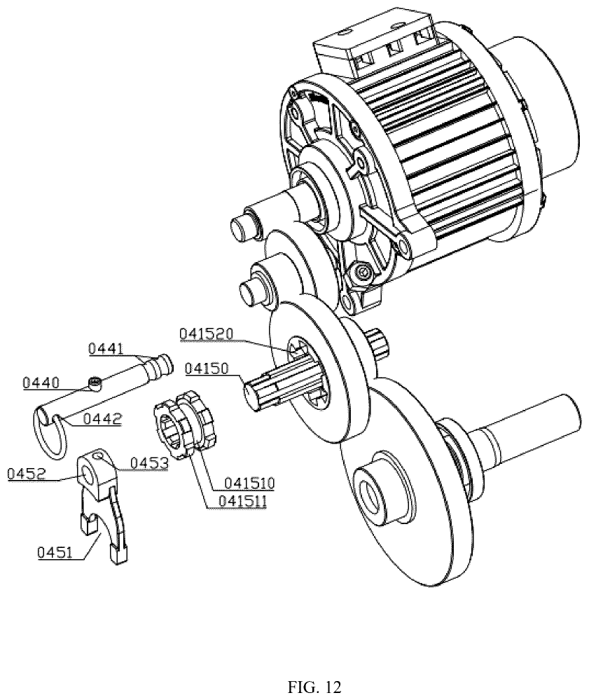

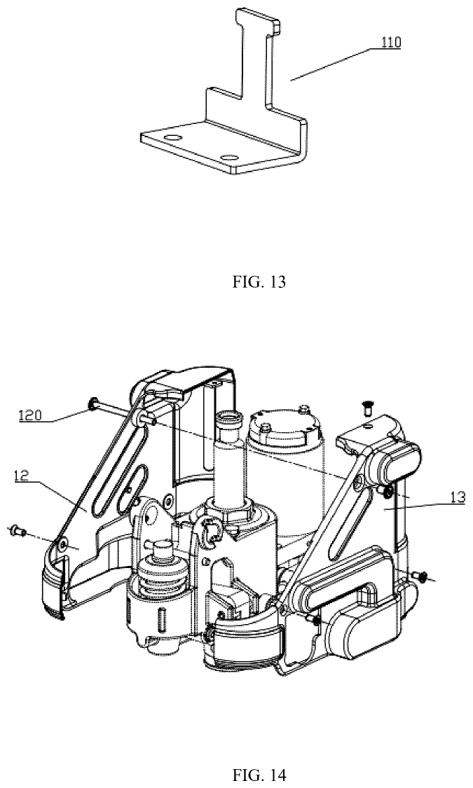

Description of reference numerals: 01 denotes a front frame; 02 denotes a rear frame plate; 03 denotes a lifting assembly; 030 denotes a pump housing; 0300 denotes an oil tank; 0301 denotes a piston rod; 0302 denotes a hand pump housing; 0303 denotes a hand pump core; 0304 denotes an oil circuit A; 0305 denotes an oil circuit B; 031 denotes a first one-way valve; 0310 denotes a steel ball; 0311 denotes a one-way valve body; 0312 denotes a valve core; 0313 denotes a volute spring; 032 denotes a return valve; 0320 denotes a needle seat; 0321 denotes a striker; 0322 denotes a limit spring; 033 denotes a gear pump; 0330 denotes an oil inlet; 0331 denotes an oil outlet; 0332 denotes an oil inlet pipe; 0333 denotes an oil outlet pipe; 0334 denotes an oil circuit C; 034 denotes a lifting motor; 035 denotes a second one-way valve; 0350 denotes an oil passage bolt; 0351 denotes a built-in one-way valve; 0352 denotes oil seal gaskets; 04 denotes a driving assembly; 040 denotes a walking mechanism; 0400 denotes a driving frame; 04001 denotes a first connecting plate; 04002 denotes a first mounting hole; 04003 denotes first support plates; 04004 denotes first fixing blocks; 04005 denotes an axle; 04006 denotes a first flange; 04007 denotes a steering pin shaft; 0401 denotes a driving wheel; 04010 denotes a second flange; 041 denotes a power mechanism; 0410 denotes a controller; 04100 denotes a first mounting plate; 0411 denotes a drive motor; 0412 denotes a gear box; 04120 denotes a box body; 04121 denotes a second threaded hole; 04122 denotes a box cover; 0413 denotes an input gear; 0414 denotes an output gear; 04140 denotes an outgoing shaft; 0415 denotes a separation mechanism; 04150 denotes a key shaft; 04151 denotes a key sleeve; 041510 denotes a first clamping slot; 041511 denotes an outer key; 04152 denotes a transmitting gear; 041520 denotes a tooth groove; 04153 denotes a drive gear; 042 denotes a secondary shaft; 0420 denotes a secondary pin pit; 0421 denotes a secondary pin column; 043 denotes a secondary gear; 044 denotes a shifting column; 0440 denotes a first concave pit; 0441 denotes second clamping slots; 0442 denotes a first hanging hole; 0443 denotes a pull ring; 045 denotes a shifting fork; 0450 denotes legs; 0451 denotes a first notch; 0452 denotes a shaft hole; 0453 denotes a first threaded hole; 046 denotes a hexagon socket head cap screw; 047 denotes a steel ball jack screw; 10 denotes a protective cover; 11 denotes a wire harness board; 110 denotes a rectangular bayonet; 12 denotes a left outer cover; 120 denotes double-ended screw; and 13 denotes a right outer cover.

### DETAILED DESCRIPTION

The present disclosure will be further described below with specific embodiments in conjunction with the accompanying drawings.

This embodiment provides a dual-purpose handling truck, including a front frame 01, the front frame 01 is provided with a fork arm for inserting into a pallet to lift goods. A rear end of the front frame 01 is connected to a rear frame plate 02, and the rear frame plate 02 plays a connecting transition role. A driving assembly 04 is connected below the rear frame plate 02, and the driving assembly 04 is configured to drive the handling truck to walk so as to realize handling of goods. A lifting assembly 03 is connected above the rear frame plate 02, and the lifting assembly 03 is configured to lift or lower the front frame 01 so as to realize lifting of goods.

The driving assembly 04 includes a walking mechanism 040 and a power mechanism 041 for driving the walking mechanism 040. The walking mechanism 040 includes a driving frame 0400, and a driving wheel 0401 installed on the driving frame 0400. The driving frame 0400 plays a supporting and connecting role. The driving wheel 0401 is installed and fixed on the driving frame 0400. The driving wheel 0401 drives the handling truck to walk. The driving wheel 0401 rolls to drive the whole handling truck to move. When the driving wheel 0401 stops rotating, the handling truck is stationary.

The power mechanism 041 controls a gear box 0412 to drive the driving wheel 0401 to rotate, so that the handling truck is electrically controlled to walk. The gear box 0412 is provided with a separation mechanism 0415, making the gear box lose transfer torque and enabling the driving wheel 0401 to rotate freely, so that the handling truck is manually pushed and pulled to walk.

The lifting assembly 03 realizes the lifting of the handling truck.

As described above, the handling truck provided by the present patent application realizes two working modes: 1. electrically controlling the movement of the handling truck, and manually or electrically controlling the lifting of the handling truck; 2. manually pushing and pulling the handling truck to walk, and manually or electrically controlling the lifting of the handling truck.

Therefore, the problem of the traditional handling truck being only able to walk in an electric driving manner through the gear box 0412, but not able to walk in a manual driving manner can be solved.

Further, the power mechanism includes a drive motor. An output end of the drive motor 0411 is connected to the gear box 0412, the gear box 0412 is installed on the other side of the driving frame 0400, and an output of the gear box 0412 is connected to the driving wheel 0401. The drive motor 0411 drives the driving wheel 0401 to rotate through the gear box 0412. The drive motor 0411 controls the gear box 0412 to drive the driving wheel 0401 to rotate, realizing the effect of electric control driving. The present disclosure employs the driving frame 0400 and the driving wheel 0401 as the force-bearing objects of the entire cart, and thus eliminates the stress design for the drive motor 0411 and the gear box 0412.

Optionally, the power mechanism 041 includes a controller 0410 installed on one side of the driving frame 0400, and the controller 0410 is electrically connected to the drive motor 0411 controlled thereby. The controller 0410 is used for electrically controlling the drive motor 0411. The controller 0410 and the gear box 0412 are located on the opposite sides of driving frame 0400, and they are not subjected to any force. In another implementation, the controller is installed on another position, such as the front frame, of the handling truck.

The lifting assembly 03 includes a pump housing 030, and the pump housing 030 is integrally formed. An oil tank 0300 is provided at one end of the pump housing 030, the oil tank 0300 is internally provided with a high-pressure chamber, the high-pressure chamber is filled with high-pressure oil, and a piston rod 0301 is arranged inside the high-pressure chamber. The high pressure oil is used for lifting the piston rod 0301. A hand pump housing 0302 is provided at the other end of the pump housing 030, and the hand pump housing 0302 is used for storing hydraulic oil. The hand pump housing 0302 is internally provided with a hand pump core 0303, and the hand pump core 0303 is used for suction and extrusion of oil.

The hand pump housing 0302 is in communication with the oil tank 0300 through an oil circuit A 0304, a first one-way valve 031 is arranged on the oil circuit A 0304, and the hand pump housing 0302 is in communication with the high-pressure oil through an oil circuit B 0305. The first one-way valve 031 is configured to control the hydraulic oil in the oil tank 0300 to only flow out and not in.

A return valve 032 is also provided on the oil circuit A 0304 for opening the first one-way valve 031 to control the high-pressure oil to flow back to the oil tank 0300. The return valve 032 is configured to open the first one-way valve 031, so as to open the oil circuit A 0304, and enable the high-pressure oil to return back to the oil tank 0300.

As described above, in the specific use process, when walking, the drive motor 0411 drives the driving wheel 0401 to rotate through the gear box 0412, or the separation mechanism 0415 makes the gears lose transfer torque, which can realize manual pushing and pulling. Manual raising: the hand pump core 0303 is lifted to form a vacuum in the hand pump housing 0302, and the oil is enabled to pass through the oil circuit A 0304 and then sucked in through the first one-way valve 031. The hand pump core 0303 is pressed down to push the oil into the high-pressure oil through the oil circuit B 0305, and thus the piston rod 0301 is lifted. Manual lowering: the return valve 032 opens the first one-way valve 031, which makes the high-pressure oil flow back to the oil tank 0300 from the oil circuit B 0305 and the oil circuit A 0304, so that the piston rod 0301 descends.

Further, the driving frame 0400 includes a first connecting plate 04001, and two first support plates 04003 that are arranged opposite to each other are provided on a lower surface of the first connecting plate 04001. The one first connecting plate 04001 and the two first support plates 04003 are assembled into a U shape. A rotatable axle 04005 is arranged between bottoms of the two first support plates 04003, and the driving wheel 0401 sleeves the axle 04005. The driving wheel 0401 rotates to achieve walking.

Optionally, the two ends of the axle 04005 are sleeved with bearings embedded in the first support plates 04003, making rotation smoother.

A steering pin shaft 04007 is inserted between tops of the two first support plates 04003. The steering pin shaft 04007 passes through a bottom of the pump housing 030 and the steering pin shaft 04007 supports the entire lifting assembly 03 to bear force. The steering pin shaft 04007 is made of solid round steel.

As described above, when it is necessary to turn, the pump housing 030 rotates to cause the steering pin shaft 04007 to drive the driving frame 0400 to implement left turning or right turning. The force applied to the driving frame 0400 is transmitted to the driving wheel 0401 through the steering pin shaft 04007, and the other components are not affected by the force, resulting in a longer service life of the entire cart.

In another embodiment, the entire lifting assembly is bolted to the entire driving frame to form a synchronously rotating structure.

Further, the first connecting plate 04001 is provided with a first mounting hole 04002 penetrating through upper and lower surfaces thereof. A first fixing block 04004 fixed by being embedding into the first mounting hole 04002 protrudes from a top surface of the first support plate 04003. The first fixing blocks 04004 are embedded into the first mounting hole 04002 in a tightly fitted manner for fixation, and then the first fixing blocks are welded to the first mounting hole, thus making the connection therebetween more firmly, and ensuring the weld seam therebetween to be smoother than that between boards welded face to face.

In another embodiment, the driving frame is integrally formed as a casting.

The axle 04005 is hollow or solid inside, and a first flange 04006 protrudes from a surface of the axle 04005. The first flange 04006 is integrally formed with the axle 04005 to ensure its strength. A second flange 04010 is arranged in the middle of the driving wheel 0401, the driving wheel 0401 is fitted into the axle 04005, and the first flange 04006 is bolted to the second flange 04010 for fixation.

Both ends of the steering pin shaft 04007 are clamped into retaining rings for fixation. The retaining rings are embedded into the steering pin shaft 04007 and fixed on the driving frame 0400, so that they will not move.

As described above, the driving wheel 0401 is bolted to the axle 04005 by the flanges, which ensures the firmness of connection while facilitating later replacement.

Further, the handling truck also includes a first mounting plate 04100. Upper and lower side edges of the first mounting plate 04100 are bent into step shapes, and are bolted and fixed to one side of the driving frame 0400. There is an interstice between the first mounting plate 04100 and the driving frame 0400. A housing of the controller 0410 is bolted and fixed to the first mounting plate 04100.

As described above, the size of the first mounting plate 04100 is designed according to the size requirements of the controller 0410. The first mounting plate 04100 serves as a platform to install the controller 0410, which reduces the direct contact between the controller 0410 and the driving frame 0400, and avoids the direct impact of vibration transmission on the controller 0410, thus having a buffering effect. According to different styles of the controller 0410, the installation design requirements can be replaced, which is more practical.

Further, the gear box 0412 includes a box body 04120, and a box cover 04122 fitted with the box body 04120, and the box body 04120 and the box cover 04122 are assembled to form an installation chamber. The box body 04120 and the box cover 04122 are made of metal materials, which are assembled and bolted together for fixation. The installation chamber formed by assembling the box body 04120 and the box cover 04122 is available for installation of parts such as gears and bearings.

A gear set is installed inside the box body to transmit torque, change speed and change the direction of torque. The separation mechanism 0415 is arranged inside the gear set. The separation mechanism 0415 enables the engagement or separation of the gear set, so that the gear set has the dual-purpose function of transmitting torque output or terminating torque output.

As described above, the separation mechanism on the gear box allows it to have two working states: one is the ability of gear engagement to transmit torque output, and the other is the ability of gear separation to terminate torque output. When the gear box cannot work, the handling truck can also be manually pushed and pulled to walk.

The separation mechanism includes a key sleeve 04151, which has an inner key and an outer key 041511. A plurality of outer keys 041511 protrude from an inner side of an outer surface of the key sleeve 04151. The outer keys are block-shaped, and their cross sections may be square, trapezoidal, triangular, or the like.

The separation mechanism 0415 includes a key shaft 04150, the key shaft 04150 is cylindrical, an outer surface of the key shaft 04150 is provided with a longitudinal keyway, and the shape of the keyway is designed according to the requirements. In addition to a spline slot, a flat keyway, a semi-circular keyway, or the like may be adopted.

The outer key of the key sleeve is engaged with the keyway of a transmitting gear. The key sleeve 04151 rotates synchronously with the key shaft 04150 and can slide in the axial direction. The keyway matching the key shaft is formed in the middle of the interior of the key sleeve 04151, which can maintain synchronous rotation of the key sleeve with the key shaft 04150. When necessary, the key sleeve can also slide axially on the key shaft 04150.

When the outer key of the key sleeve is separated from the keyway on the transmitting gear, torque transmission between the transmitting gear and the key sleeve is lost.

As described above, the key sleeve and the transmitting gear are sleeved outside the key shaft. The key sleeve is engaged with the transmitting gear, the transmitting gear rotates to drive the key sleeve to rotate, and the key shaft follows the rotation, so that the torque transmission of the gear set is realized.

The key sleeve is separated from the transmitting gear, the transmitting gear rotates relative to the key shaft, and the key sleeve and the key shaft do not follow the rotation. Therefore, the torque transmission of the gear set is terminated.

Further, a housing of the drive motor 0411 is bolted to the box body 04120 for fixation. An output shaft of the drive motor 0411 is inserted into the box body 04120, and the output shaft of the drive motor 0411 is engaged with an input gear 0413. The drive motor 0411 drives the input gear 0413 to rotate. In another embodiment, the input gear is formed by teeth provided on the output shaft of the drive motor.

The key sleeve 04151 is located at one end of the key shaft 04150. The transmitting gear 04152 sleeves the middle of the key shaft 04150. Teeth are provided on an outer surface of the transmitting gear 04152. The transmitting gear 04152 is engaged with the input gear 0413 and the transmitting gear 04152 is rotatable around the key shaft 04150. A smooth circular hole is reserved in the middle of the interior of the transmitting gear 04152, which is fitted onto the key shaft 04150 without being affected by the keyway.

A tooth groove 041520 that matches the outer key 041511 is formed in one side of the transmitting gear 04152. The outer key 041511 is embedded into the tooth groove 041520 and engaged therewith, and the key sleeve 04151 rotates synchronously with the transmitting gear 04152, while the key sleeve drives the key shaft 04150 to rotate. The outer key 041511 is separated from the tooth groove 041520, the key sleeve 04151 does not rotate, and the key shaft 04150 also stops rotating.

A drive gear 04153 is arranged at the other end of the key shaft 04150. The drive gear may be a fixed gear piece that is additionally sleeved outside the key shaft, or teeth provided on the surface of the key shaft.

The key shaft 04150 drives the drive gear 04153 to rotate, and the drive gear 04153 is engaged with an outgoing shaft 04140 for synchronous rotation. The outgoing shaft is provided with teeth for engagement. A transmission shaft is directly inserted into the driving wheel for enabling walking.

In another embodiment, the outgoing shaft 04140 is embedded in the middle of the output gear 0414, the outgoing shaft 04140 penetrates out of the box body 04120 and is inserted into the driving wheel to drive rotation. The input gear 0413 and the output gear 0414 are existing conventional gears.

The drive gear 04153 and the output gear 0414 are engaged with each other and rotate synchronously. A keyway is formed in the middle of the drive gear 04153, which is inserted into a keyway of the key shaft 04150 to form a connection with each other. The drive gear 04153 rotates synchronously with the key shaft 04150.

The input gear 0413, the output gear 0414, the transmitting gear 04152, the drive gear 04153, and the key shaft 04150 are clamped between the box body 04120 and the box cover 04122 for fixation.

Optionally, the end of the drive motor 0411, both ends of the key shaft 04150, and both ends of the output gear 0414 are respectively sleeved in bearings to facilitate rotation.

As described above, in the specific use process, when the gear box is electrically driven: the key sleeve 04151 is assembled with the transmitting gear 04152, and the outer key 041511 is embedded into the tooth groove 041520. The output shaft of the drive motor 0411 rotates, driving the input gear 0413 and the transmitting gear 04152 to rotate. The key sleeve 04151 rotates, driving the key shaft 04150, the drive gear 04153, the output gear 0414, the outgoing shaft 04140 to rotate, and the driving wheel to rotate.

Switch to manual walking: the key sleeve 04151 is push apart from the transmitting gear 04152 for separation, and the torque output of the gear set will be terminated. The driving wheel is manually pushed and pulled for walking, the drive shaft rotates, the output gear 0414 rotates, the drive gear 04153 rotates, and then the key shaft 04150 and the key sleeve 04151 rotate. But the transmitting gear 04152 does not rotate and remains stationary relative to the key shaft. It can be applied to situation where the drive motor 0411 is damaged and unable to work, or the handling truck is stuck on the road when the drive motor 0411 is powered off. By using the separation mechanism 0415 to break the engaging connection between the gears, manual pushing and pulling can be achieved, which is safer and more practical. It solves the problem that the existing gear box 0412 is unavailable in driving and thus the handling truck cannot move.

Further, the handling truck also includes a secondary shaft 042, where a secondary pin pit 0420 is provided at one end of the secondary shaft 042, the input gear 0413 is fitted into the secondary shaft 042 and embedded into a secondary pin column 0421 for clamping and fixing, a secondary gear 043 protrudes from a surface of the other end of the secondary shaft 042, and the secondary gear 043 is engaged with the transmitting gear 04152.

As described above, the secondary gear 043 is added between the drive motor 0411 and the separation mechanism 0415 to perform a speed reduction function for achieving a desired speed reduction ratio.

Optionally, in order to meet the design requirements of different reduction ratios, a multistage gear may be arranged between the drive motor 0411 and the separation mechanism 0415, and then may be engaged with the transmitting gear 04152 of the separation mechanism 0415, which is not limited to the secondary gear.

Further, an outer surface of the key sleeve 04151 is recessed in the middle to form an annular first clamping slot 041510. An external tool can be inserted into the first clamping slot 041510 to toggle the key sleeve 04151 to move for use. The handling truck also includes a shifting column 044. The shifting column 044 is rod-shaped, and a tail end of the shifting column 044 passes through the box cover 04122 and is then inserted into the box body 04120. A head end of the shifting column 044 is left outside the box cover 04122, and the box body 04120 and the box cover 04122 wrap the separation mechanism 0415. A shifting fork 045 is fixed on the shifting column 044, the shifting fork 045 includes two legs 0450, and an arc-shaped first notch 0451 is reserved between the two legs 0450. A top of the shifting fork 045 is provided with a shaft hole 0452 for the insertion and fixation of the shifting column 044.

As described above, by inserting and removing the shifting column 044, the shifting fork 045 is driven to move. The top of the shifting fork 045 is blocked by the box cover 04122 to prevent the shifting column 044 from being completely pulled out. The shifting column 044 is erected to move between the box body 04120 and the box cover 04122.

The first clamping slot 041510 of the key sleeve 04151 is clamped by the two legs 0450 of the shifting fork 045. The shifting column 044 drives the shifting fork 045 to move, and the shifting fork 045 synchronously drives the key sleeve 04151 to move on the key shaft 04150 so as to realize the separation or assembly of the key sleeve 04151 and the transmitting gear 04152.

As described above, during the specific use process, for the convenience and safety of use, the shifting column 044 and the shifting fork 045 are additionally arranged. The shifting fork 045 clamps the key sleeve 04151, and the shifting column 044 is fixedly connected to the shifting fork 045. The shifting fork 045 is driven to move by inserting and removing the shifting column 044, and the key sleeve 04151 moves with the shifting fork 045, so as to realize the assembly or separation of the key sleeve and the transmitting gear 04152.

Further, a middle end surface of the shifting column 044 is recessed to form a first concave pit 0440. There is a through first threaded hole 0453 is provided in the shaft hole 0452, and a hexagon socket head cap screw 046 is screwed into the first threaded hole 0453 and inserted into the first concave pit 0440 for fixation.

As described above, the hexagon socket head cap screw 046 is screwed in between the shifting fork 045 and the shifting column 044. The screw connection is adopted for replacement, which also meets the design requirements for overall disassembly. In addition to the hexagon socket head cap screw 046, other screws can also be used, such as a headless jack screw.

A tail end surface of the shifting column 044 is provided with two circles of side-by-side annular second clamping slots 0441. The second clamping slots 0441 are arranged adjacent to each other, and the second clamping slots 0441 are designed to surround the shifting column 044. The box body 04120 is provided with a second threaded hole 04121. A steel ball jack screw 047 is screwed into the second threaded hole 04121 and jacked against the second clamping slots 0441 to play a limiting role.

As described above, after the shifting column 044 is inserted and removed for many times, in order to avoid the phenomenon that the key sleeve 04151 and the transmitting gear 04152 are not assembled or separated in place since the shifting column 044 is inserted or pulled out excessively during the inserting and removing processes, the second clamping slots 0441 are provided at the tail end of the shifting column 044, and a head steel ball of the steel ball jack screw 047 is jacked into the second clamping slots 0441, which means that the shifting column 044 is in place. An operator will have the hand feeling and acoustic judgment of the collision of the steel ball jack screw 047, which is more accurate. The two second clamping slots 0441 represent two working positions.

A through first hanging hole 0442 is provided in a head end surface of the shifting column 044, and a pull ring 0443 is arranged in the first hanging hole 0442 in a penetrating manner.

As described above, the operator's finger is hooked on the pull ring 0443 to facilitate pulling of the shifting column 044.

Further, a gear pump 033 is arranged at one side of the pump housing 030, and an oil inlet 0330 and an oil outlet 0331 are provided on the gear pump 033. The gear pump 033 is connected to a lifting motor 034, and the lifting motor 034 is configured to control the gear pump 033 to absorb oil or inject oil. An oil inlet pipe 0332 is in communication between the oil inlet 0330 and the oil tank 0300.

An oil outlet pipe 0333 is connected to the oil outlet 0331, the oil outlet pipe 0333 is in communication with the high-pressure oil through an oil circuit C 0334, and a second one-way valve 035 is provided on the oil circuit C 0334.

As described above, electric lifting: the lifting motor 034 works, and the oil in the oil tank 0300 is sucked in by the gear pump 033, injected into the oil outlet pipe 0333, and then pumped into the high-pressure oil through the second one-way valve 035, causing the piston rod 0301 to ascend. Manual lowering: the first one-way valve 031 is opened through an oil return valve, and the high-pressure oil is enabled to flow back to the oil tank 0300 through the oil circuit B 0305, causing the piston rod 0301 to descend.

In the same way, when using electric lifting, manual lifting may also be used. The hand pump core 0303 sucks oil into the hand pump housing 0302, and then injects same into the high-pressure oil through the oil circuit B 0305, which can also raise the piston rod 0301, achieving the effect of electric and manual lifting together. The piston rod 0301 is lifted faster, thus saving time.

Further, the first one-way valve 031 includes a steel ball 0310, a one-way valve body 0311, a valve core 0312 and a volute spring 0313. The valve core 0312 is inserted into the one-way valve body 0311, the volute spring 0313 is jacked against the one-way valve body 0311, the steel ball 0310 is jacked against the valve core 0312, and the steel ball 0310 is located at an oil outlet part of the oil circuit A 0304.

As shown above, the steel ball 0310 is squeezed by an elastic force and blocked at the oil outlet part of the oil circuit A 0304. Only when oil is sucked, the steel ball 0310 is pushed open. On the contrary, the steel ball 0310 will not move under the oil pressure, which will not cause backflow.

The oil return valve is located directly opposite the first one-way valve 031, and the steel ball 0310 is located on one side of the oil return valve. The oil return valve includes a needle seat 0320, a striker 0321 and a limit spring 0322. A tail of the striker 0321 is inserted into the needle seat 0320 to play a limiting role, and a head of the striker 0321 is slender and inserted into the limit spring 0322. The limit spring 0322 is jacked against the striker 0321 for fixation. The striker 0321 is configured to push away the steel ball 0310 to achieve oil return.

As shown above, in a normal state, the head of the striker 0321 is pressed away from the steel ball 0310 by the limit spring 0322. When it is necessary to return oil to lower the piston rod 0301, the tail of the striker 0321 is pushed inward, and the head of the striker 0321 will push the steel ball away and leave the oil outlet part of the oil circuit A 0304. The high-pressure oil will flow back to the oil tank 0300 along the oil circuit B 0305, the piston rod 0301 descends completely, the striker 0321 is released, and the steel ball will reset to prepare for the next lifting.

The second one-way valve 035 includes an oil passage bolt 0350, a built-in one-way valve 0351 and an oil seal gasket 0352, where the built-in one-way valve 0351 is arranged inside the oil passage bolt 0350, the oil passage bolt 0350 is in communication between the oil outlet pipe 0333 and the oil tank 0300, and the oil seal gaskets 0352 is clamped between the oil passage bolt 0350 and the pump housing 030 for fixation.

As described above, the oil passage bolt 0350 is in threaded connection with the pump housing 030 and in communication with the oil outlet pipe 0333, and a side wall of the oil passage bolt 0350 is provided with a hole, through which the oil can pass in and out. The built-in one-way valve 0351 plays a role of one-way oil delivery, with a single direction. The oil seal gasket 0352 is used for sealing to avoid oil leakage.

Further, the handling truck further includes a protective cover 10. The protective cover 10 is bent into a cover shape, a top of the protective cover 10 fits the first connecting plate 04001 and is fixedly connected through bolts, and a surface body of the protective cover 10 covers the entire driving assembly 04.

As described above, the protective cover 10 is made of a metal plate or plastic material and is fixed to the driving frame 0400 by bolts for easy replacement. The protective cover 10 covers and protects the entire driving assembly 04, which also indirectly protects the operator's feet from being crushed.

The handling truck further includes a wire harness board 11. The wire harness board 11 is bent into an L shape, a bottom of the wire harness board 11 is connected and fixed to the first connecting plate 04001 through bolts, and a top of the wire harness board 11 is recessed from two side faces to form a rectangular bayonet 110.

As described above, the wire harness board 11 is made by bending a metal sheet into an L shape, and the rectangular bayonet 110 on the wire harness board 11 can jam and limit the wires connected to the controller 0410, so as to prevent the wires from running and winding, which is safer.

The handling truck further includes a left outer cover 12 and a right outer cover 13, where the left outer cover 12 and the right outer cover 13 respectively cover a left side face and a right side face of the pump housing 030, and a double-ended screw 120 passes through the left outer cover 12 and the right outer cover 13 for realizing fixed connection therebetween.

As described above, the left outer cover 12 and the right outer cover 13 are made of metal sheets, and the two outer covers are respectively matched with the contours of two side faces of the pump housing 030, thus protecting the pump housing by wrapping.

In the description of the present disclosure, it should be understood that the orientations or positional relationships indicated by the terms such as “upper”, “lower”, “top”, “bottom”, “inner”, and “outer” are based on the orientations or positional relationships shown in the drawings, or the orientations or positional relationships in which the product of the present disclosure is customarily placed when in use, or the orientations or positional relationships commonly understood by those skilled in the art, which are only for convenience in describing the present disclosure and simplifying the description, and do not indicate or imply that the devices or elements referred to must have particular orientations, or must be constructed and operated in particular orientations. Therefore, it cannot be construed as a limitation on the present disclosure.

In addition, the descriptions of “first”, “second”, and the like are only used for descriptive purposes, and cannot be understood as indicating or implying their relative importance or implying the number of indicated technical features. In the present disclosure, unless otherwise clearly specified and limited, terms “install”, “arrange”, “connect”, “fix”, “rotate” and the like should be understood in a generalized manner, for example, “connect” may be understood as fixed connection, detachable connection, or integration; or may be understood as mechanical connection, or electrical connection.

The above embodiments are only the exemplary embodiments of the present disclosure, and are not intended to limit the scope of protection of the present disclosure accordingly. Therefore, any equivalent changes made according to the structure, shape, and principle of the present disclosure shall be covered by the scope of protection of the present disclosure.

What is claimed is:

1. A dual-purpose handling truck, comprising a front frame, wherein a rear end of the front frame is connected to a rear frame plate, a driving assembly is connected below the rear frame plate, and a lifting assembly is connected above the rear frame plate;
the driving assembly comprises a walking mechanism and a power mechanism for driving the walking mechanism; the walking mechanism comprises a driving frame, and a driving wheel is installed on the driving frame;
the power mechanism controls a gear box to drive the driving wheel to rotate, so that the handling truck is electrically controlled to walk; the gear box is provided with a separation mechanism, making the gear box lose transfer torque and enabling the driving wheel to rotate freely, so that the handling truck is manually pushed and pulled to walk; and
the lifting assembly realizes the lifting of the handling truck.

2. The dual-purpose handling truck according to claim 1, wherein
the power mechanism comprises a drive motor; an output end of the drive motor is connected to the gear box, the gear box is installed on the driving frame, and an output end of the gear box is connected to the driving wheel; the drive motor drives the driving wheel to rotate through the gear box;
the lifting assembly comprises a pump housing, an oil tank is provided at one end of the pump housing, the oil tank is internally provided with a high-pressure chamber, the high-pressure chamber is filled with high-pressure oil, and a piston rod is arranged inside the high-pressure chamber; a hand pump housing is provided at the other end of the pump housing, and a hand pump core is arranged inside the hand pump housing;
the hand pump housing is in communication with the oil tank through an oil circuit A, a first one-way valve is arranged on the oil circuit A, and the hand pump housing is in communication with the high-pressure oil through an oil circuit B; and a return valve is provided on the oil circuit A for opening the first one-way valve to control the high-pressure oil to flow back to the oil tank.

3. The dual-purpose handling truck according to claim 2, wherein the driving frame comprises a first connecting plate, and two first support plates that are arranged opposite to each other are provided on a lower surface of the first connecting plate; a rotatable axle is arranged between bottoms of the two first support plates, and the driving wheel sleeves the axle;
a steering pin shaft is inserted between tops of the two first support plates; the steering pin shaft passes through a bottom of the pump housing and supports the entire lifting assembly to bear force;
the first connecting plate is provided with a first mounting hole penetrating through upper and lower surfaces thereof; a first fixing block fixed by being embedding into the first mounting hole protrudes from a top surface of the first support plate;
the axle is hollow inside, and a first flange protrudes from a surface of the axle; a second flange is arranged in the middle of the driving wheel, the driving wheel is fitted into the axle, and the first flange is bolted to the second flange for fixation; and
both ends of the steering pin shaft are clamped into retaining rings for fixation.

4. The dual-purpose handling truck according to claim 1, wherein the gear box comprises a box body, and a box cover fitted with the box body, and the box body and the box cover are assembled to form an installation chamber;
a gear set is installed inside the box body, and the separation mechanism is arranged inside the gear set; and
the separation mechanism enables the engagement or separation of the gear set, so that the gear set has the function of transmitting torque output or terminating torque output.

5. The dual-purpose handling truck according to claim 2, wherein the gear box comprises a box body, and a box cover fitted with the box body, and the box body and the box cover are assembled to form an installation chamber;
a gear set is installed inside the box body, and the separation mechanism is arranged inside the gear set; and
the separation mechanism enables the engagement or separation of the gear set, so that the gear set has the function of transmitting torque output or terminating torque output.

6. The dual-purpose handling truck according to claim 3, wherein the gear box comprises a box body, and a box cover fitted with the box body, and the box body and the box cover are assembled to form an installation chamber;
a gear set is installed inside the box body, and the separation mechanism is arranged inside the gear set; and
the separation mechanism enables the engagement or separation of the gear set, so that the gear set has the function of transmitting torque output or terminating torque output.

7. The dual-purpose handling truck according to claim 4, wherein
the gear set comprises an input gear and an outgoing shaft;
a housing of the drive motor is bolted to the box body for fixation; an output shaft of the drive motor is inserted into the box body, and the output shaft of the drive motor is engaged with the input gear; the outgoing shaft penetrates out of the box body and is inserted into the driving wheel to drive rotation;
the separation mechanism comprises a key sleeve, an inner key of the key sleeve is engaged with a key shaft, and an outer key of the key sleeve is engaged with a keyway of a transmitting gear;
the key sleeve is movable axially on the key shaft; when the outer key of the key sleeve is separated from the keyway on the transmitting gear, torque transmission between the transmitting gear and the key sleeve is lost;
the key sleeve is located at one end of the key shaft; the transmitting gear sleeves the middle of the key shaft; the transmitting gear is engaged with the input gear and the transmitting gear is rotatable around the key shaft; a tooth groove that meshes with the outer key of the key sleeve is formed in a side face of the transmitting gear; the outer key is embedded into the tooth groove, and the key sleeve rotates synchronously with the transmitting gear, while the key sleeve drives the key shaft to rotate;
a drive gear is arranged at the other end of the key shaft; the key shaft drives the drive gear to rotate, and the drive gear is engaged with the outgoing shaft for synchronous rotation; and
the input gear, the outgoing shaft, the transmitting gear, the drive gear, and the key shaft are clamped between the box body and the box cover for fixation.

8. The dual-purpose handling truck according to claim 5, further comprising a secondary shaft, wherein a secondary pin pit is provided at one end of the secondary shaft, the input gear is fitted into the secondary shaft and embedded into a secondary pin column for clamping and fixing, a secondary gear protrudes from a surface of the other end of the secondary shaft, and the secondary gear is engaged with the transmitting gear.

9. The dual-purpose handling truck according to claim 5, wherein an outer surface of the key sleeve is recessed in the middle to form an annular first clamping slot;
the handling truck also comprises a shifting column; the shifting column is rod-shaped, and a tail end of the shifting column passes through the box cover and is then inserted into the box body; a shifting fork is fixed on the shifting column, the shifting fork comprises two legs, and an arc-shaped first notch is reserved between the two legs; a top of the shifting fork is provided with a shaft hole for the insertion and fixation of the shifting column;
the first clamping slot of the key sleeve is clamped by the two legs of the shifting fork; the shifting column drives the shifting fork to move, and the shifting fork synchronously drives the key sleeve to move on the key shaft so as to realize the separation or assembly of the key sleeve and the transmitting gear;
a middle end surface of the shifting column is recessed to form a first concave pit; a through first threaded hole is provided in the shaft hole, and a hexagon socket head cap screw is screwed into the first threaded hole and inserted into the first concave pit for fixation;
a tail end surface of the shifting column is provided with two circles of side-by-side annular second clamping slots; the box body is provided with a second threaded hole, and a steel ball jack screw is screwed into the second threaded hole and jacked against the second clamping slots to play a limiting role; and
a through first hanging hole is provided in a head end surface of the shifting column, and a pull ring is arranged in the first hanging hole in a penetrating manner.

10. The dual-purpose handling truck according to claim 1, wherein a gear pump is arranged at one side of the pump housing, and an oil inlet and an oil outlet are provided on the gear pump; the gear pump is connected to a lifting motor, and the lifting motor is configured to control the gear pump to suck oil or inject oil; an oil inlet pipe is in communication between the oil inlet and the oil tank; and
an oil outlet pipe is connected to the oil outlet, the oil outlet pipe is in communication with the high-pressure oil through an oil circuit C, and a second one-way valve is provided on the oil circuit C.

11. The dual-purpose handling truck according to claim 2, wherein a gear pump is arranged at one side of the pump housing, and an oil inlet and an oil outlet are provided on the gear pump; the gear pump is connected to a lifting motor, and the lifting motor is configured to control the gear pump to suck oil or inject oil; an oil inlet pipe is in communication between the oil inlet and the oil tank; and
an oil outlet pipe is connected to the oil outlet, the oil outlet pipe is in communication with the high-pressure oil through an oil circuit C, and a second one-way valve is provided on the oil circuit C.

12. The dual-purpose handling truck according to claim 3, wherein a gear pump is arranged at one side of the pump housing, and an oil inlet and an oil outlet are provided on the gear pump; the gear pump is connected to a lifting motor, and the lifting motor is configured to control the gear pump to suck oil or inject oil; an oil inlet pipe is in communication between the oil inlet and the oil tank; and
an oil outlet pipe is connected to the oil outlet, the oil outlet pipe is in communication with the high-pressure oil through an oil circuit C, and a second one-way valve is provided on the oil circuit C.

13. The dual-purpose handling truck according to claim 4, wherein a gear pump is arranged at one side of the pump housing, and an oil inlet and an oil outlet are provided on the gear pump; the gear pump is connected to a lifting motor, and the lifting motor is configured to control the gear pump to suck oil or inject oil; an oil inlet pipe is in communication between the oil inlet and the oil tank; and
an oil outlet pipe is connected to the oil outlet, the oil outlet pipe is in communication with the high-pressure oil through an oil circuit C, and a second one-way valve is provided on the oil circuit C.

14. The dual-purpose handling truck according to claim 5, wherein a gear pump is arranged at one side of the pump housing, and an oil inlet and an oil outlet are provided on the gear pump; the gear pump is connected to a lifting motor, and the lifting motor is configured to control the gear pump to suck oil or inject oil; an oil inlet pipe is in communication between the oil inlet and the oil tank; and
an oil outlet pipe is connected to the oil outlet, the oil outlet pipe is in communication with the high-pressure oil through an oil circuit C, and a second one-way valve is provided on the oil circuit C.

15. The dual-purpose handling truck according to claim 6, wherein a gear pump is arranged at one side of the pump housing, and an oil inlet and an oil outlet are provided on the gear pump; the gear pump is connected to a lifting motor, and the lifting motor is configured to control the gear pump to suck oil or inject oil; an oil inlet pipe is in communication between the oil inlet and the oil tank; and
an oil outlet pipe is connected to the oil outlet, the oil outlet pipe is in communication with the high-pressure oil through an oil circuit C, and a second one-way valve is provided on the oil circuit C.

16. The dual-purpose handling truck according to claim 7, wherein a gear pump is arranged at one side of the pump housing, and an oil inlet and an oil outlet are provided on the gear pump; the gear pump is connected to a lifting motor, and the lifting motor is configured to control the gear pump to suck oil or inject oil; an oil inlet pipe is in communication between the oil inlet and the oil tank; and
an oil outlet pipe is connected to the oil outlet, the oil outlet pipe is in communication with the high-pressure oil through an oil circuit C, and a second one-way valve is provided on the oil circuit C.

17. The dual-purpose handling truck according to claim 8, wherein the first one-way valve comprises a steel ball, a one-way valve body, a valve core and a volute spring; the valve core is inserted into the one-way valve body, the volute spring is jacked against the one-way valve body, the steel ball is jacked against the valve core, and the steel ball is located at an oil outlet part of the oil circuit A;
an oil return valve is located directly opposite the first one-way valve, and the steel ball is located on one side of the oil return valve; the oil return valve comprises a needle seat, a striker and a limit spring; a tail of the striker is inserted into the needle seat to play a limiting role, and a head of the striker is slender and inserted into the limit spring; the limit spring is jacked against the striker for fixation; the striker is configured to push away the steel ball to achieve oil return; and
the second one-way valve comprises an oil passage bolt, a built-in one-way valve and an oil seal gasket, wherein the built-in one-way valve is arranged inside the oil passage bolt, the oil passage bolt is in communication between the oil outlet pipe and the oil tank, and the oil seal gasket is clamped between the oil passage bolt and the pump housing for fixation.

18. The dual-purpose handling truck according to claim 2, further comprising a protective cover, wherein the protective cover is bent into a cover shape, a top of the protective cover fits the first connecting plate and is fixedly connected through bolts, and a surface body of the protective cover covers the entire driving assembly;
further comprising a wire harness board, wherein the wire harness board is bent into an L shape, a bottom of the wire harness board is connected and fixed to the first connecting plate through bolts, and a top of the wire harness board is recessed from two side faces to form a rectangular bayonet; and
further comprising a left outer cover and a right outer cover, wherein the left outer cover and the right outer cover respectively cover a left side face and a right side face of the pump housing, and a double-ended screw passes through the left outer cover and the right outer cover for realizing fixed connection therebetween.
